(19) United States
(12) Patent Application Publication
(10) Pub. No.: US 2015/0099637 A1
(43) Pub. Date: Apr. 9, 2015

(54) NEW METHOD TO IMPROVE THE PERFORMANCE OF HERBICIDE FORMULATIONS

(71) Applicant: Bomi Framroze, Mumbai (IN)

(72) Inventor: Bomi Framroze, Mumbai (IN)

(21) Appl. No.: 14/046,970

(22) Filed: Oct. 6, 2013

(51) Int. Cl. A01N 25/22

(52) U.S. Cl. CPC A01N 25/22
USPC 504/339

(57) ABSTRACT

An improved herbicidal suspension concentrate comprising at least one anilide herbicide compound as the active ingredient and containing at least one carbamate compound as a crystallization suppressant, the resulting formulation exhibiting improved caking, gelling and settling properties and resulting in a more even distribution of active ingredient.

### FIELD OF THE INVENTION

The present invention relates to a herbicidal suspension concentrate, more particularly to a herbicidal suspension concentrate comprising at least one anilide herbicide compound as the active ingredient and containing at least one carbamate compound as a crystallization suppressant, the resulting formulation exhibiting improved caking, gelling and settling properties, resulting in the application of a more even distribution of active ingredient.

### BACKGROUND OF THE INVENTION

Suspension concentrate compositions also called aqueous flowable compositions are concentrated suspensions of water-insoluble compounds in an aqueous system. The present invention relates to producing a more stable suspension concentrate of anilide herbicide compounds.

Suspension concentrates of anilide herbicides frequently contain between 10% to 80%, by weight, of the solid herbicide which provides for a better method for handling these relatively water insoluble herbicides in an aqueous medium. Suspension concentrates have the desirable characteristic of being thick liquids that can be poured or pumped, eliminating some of the problems, like dusting, that are possible in solid compositions as wettable powders and granular formulations. Further, these water-based concentrates also have the added advantage of not requiring the use of organic solvents, usually present in emulsifiable concentrate formulations.

For these reasons, it is desirable to formulate anilide herbicides into suspension concentrates or aqueous flowables.

However, formulations of anilide herbicides often exhibit stability problems related to rapid crystal formation of the low-melting active ingredients. Gelling, caking and settling due to large crystals being formed in the final suspension concentrate formulation result in instability, difficulty in processing and unreliability in usage. Thus, formulating suspension concentrate compositions of anilide herbicides wherein this gelling, caking and settling are minimized is crucial to the stability of anilide herbicide suspension concentrates which is then necessary to obtain an even distribution of active compound for herbicidal application. For instance, the anilide herbicide propanil, is particularly difficult to formulate into a suspension concentrate and some references have tried to address these formulation problems.

The problems associated with the development of suspension concentrate compositions containing low melting active ingredients are described in German Patent Application DE 3302648. It describes the use of a co-solvent such as phthalic acid C1-C12 alkyl esters in combination with the active ingredient as an alternative to a suspension concentrate containing low melting active ingredients. Such alternate methods were explored due to the difficulty in preparing stable suspension concentrates of anilide herbicides by various techniques, including those described in EP 0332912 which describes other adjuvants.

These references do not address ways helpful to the development of anilide herbicide suspension concentrate compositions to produce a stable and evenly efficacious end-use product.

It is an object of the present invention to provide a stable aqueous suspension concentrate composition or aqueous flowable composition of the low-melting anilide herbicides, either alone or in combination with other higher melting pesticides by the unexpected addition of aromatic carbamate compounds as crystallization suppressants, acting at very low rates of addition. Although the addition of carbamate insecticides with anilide herbicides is known (Control of Propanil-Resistant Barnyardgrass (Echinochloa crusgalli) in Rice (Oryza sativa) with Carbaryl/Propanil Mixtures. Daou, H., Albert, R. Weed Technology. (1999) 13, page 65-70) this and other reports only discuss the potentiation of the biological efficacy of propanil as a herbicide and do not mention or infer any formulation benefit or improvement. These and other objects will become more apparent by the detailed description of the invention provided herein.

### SUMMARY OF THE INVENTION

The present invention relates to a stable aqueous suspension concentrate composition or aqueous flowable composition comprising anilide herbicides, alone or in combination with other higher melting pesticides. Typically, the compositions of the invention comprise, on a weight to volume basis, about 20.0% to 50.0% anilide herbicide, preferably Propanil; 0% to 40.0% of one or more secondary pesticide(s); 5.0% to 20.0% co-formulants, as described in more detail hereinbelow; 0.001% to 1% of a carbamate compound as a crystallization suppresant and about 20.0% to 70.0% water. Preferred compositions provide for propanil as the anilide herbicide and carbaryl as the carbonate compound

The stable compositions of the invention are readily prepared by forming an emulsion of propanil in water containing the coformulants, surfactants, dispersing and/or wetting agents, antifoaming agents, crystal inhibiting agents and suspending agents. This is then cooled and milled to obtain an average particle size of suspended particles of less than 20 microns, preferably less than 5 microns.

### DETAILED DESCRIPTION OF THE INVENTION

Compositions of the invention typically comprise on a weight to volume basis, about 30.0% to 50.0% anilide herbicide, preferably propanil; about 5.0% to 20.0% of coformulants, such as surfactants, dispersing agents, wetting agents, antifreezing agents, antifoaming agents, thickening agents, gums, preservatives; 0.02% to 2% of a carbamate compound, preferably carbaryl and 20.0% to 70.0% water.

Coformulants

Other pesticides suitable for addition into the suspension concentrate formulation of anilide herbicides, preferably propanil, include ureas, triazines, imidazolinones, alone or in combination. Additionally, water-soluble pesticides, such as difenzoquat, amine salts, alkali or alkali metal salts of phenoxy acetic acids, bromoxynil, and imidazolinyl carboxylic acids and the like may readily be incorporated into the stable aqueous suspension concentrate compositions of this invention.

Surfactants (including dispersing agents and/or wetting agents) suitable in the aqueous suspension compositions of the invention containing solid propanil include: ethylene oxide/propylene oxide condensates; alkyl,aryl- and aryl, arylethoxylates and derivatives; lignosulfonates; cresol- and naphthaleneformaldehyde condensates and the sulfonates; polycarboxylates and derivatives; Tersperse, Surfonic TDA-6; alkyl,aryl- and aryl,arylethoxylates and their derivatives, cresol formaldehyde condensates and their sulfonates, naphthalene formaldehyde condensates and their sulfonates and lignosulfonates; and mixtures thereof. Suspending agents such as polysaccharide gums like Xanthan gum, guar gum; gum arabic and cellulose derivatives, and the like are also suitable for addition to the hot emulsion in amounts of about 0.02% to 3.0%, on a weight to volume basis.

Preservatives to prevent microbial spoiling of the compositions of the invention are included as necessary.

Siliconic antifoaming agents are also useful in the present compositions.

Antifreezing agents such as ethylene glycol, propylene glycol, other glycols, glycerine or urea may then be added to the resulting aqueous suspension concentrate compositions.

Crystallization suppressing carbamate compounds such as carbaryl and bendiocard are unexpected and important adjuvant coformulants in the present invention.

Process of Manufacturing

Stable aqueous suspension concentrate compositions of propanil may be prepared by a variety of methods. For example, a stable composition may be prepared by emulsifying propanil in water containing surfactant(s), wetting agent and antimicrobial agent and wet milling the resultant suspension to achieve the desired droplet size. The resulting emulsion of desired particle size <5 microns is agitated and additional coformulants, such as antifreezing agents and the crystallization suppressant carbamate compound, such as carbaryl or bendiocard is added to result in a superior suspension concentrate formulation.

Surprisingly, it has been found that a more stable and superior shelf-life aqueous suspension concentrate composition of propanil when the composition contains at least 0.02% w/v of a carbamate compound, preferably carbaryl or bendiocard.

Composition

Unexpectedly, stable, superior shelf-life aqueous suspension concentrate compositions of anilide herbicides, preferably propanil, may be prepared by the above methods containing, on a weight to volume basis:

30.0% to 50.0% anilide herbicide; preferably propanil

0.05% to 1.0% antifoaming agents;

2.0% to 20.0% antifreezing agents;

2.0% to 20.0% surfactants and mixture of surfactants (wetting and dispersing agents);

0.05% to 3.0% thickening agents;

0.01% to 2.5% preservatives;

0.02% to 2.0% carbamate compounds; preferably carbaryl

and sufficient water to total 100%.

These compositions are stable with less sedimentation of active component during accelerated storage tests at 54° C. and most importantly, the application of these compositions can result in a more even dispersion of the active component.

Those skilled in the art of suspension concentration formulations will recognize that individual methods for addition, mixing and milling may be selected in part based on the method of application for the suspension concentrate being prepared and generally the methods of formulation that may be used in the process of this invention can be, without intended limitation, any such equipment or method known to one skilled in the art.

### EXAMPLE 1

Preparation of stable aqueous suspension concentrate compositions of propanil without addition of the carbamate compounds.

An aqueous solution containing surfactants, preservatives and wetting agents at 25° C. is prepared. Then, the 40% w/v propanil solid is added and agitated sufficiently to obtain an emulsion and the resulting aqueous composition is milled to achieve the desired average particle size of suspended particles of less than 5 microns. Finally additional anti-freeze agents, thickening agents and antifoaming agents, as desired, are admixed with the aqueous composition to give the resultant aqueous suspension concentrate, Example 1.

### EXAMPLE 2

Preparation of stable aqueous suspension concentrate compositions of propanil with addition of the carbamate compound, carbaryl.

An aqueous suspension concentrate is prepared exactly as in Example 1 but with the addition of 0.04% w/v carbaryl compound as an additional adjuvant to give the resultant aqueous suspension concentrate, Example 2.

### EXAMPLE 3

An aqueous suspension concentrate is prepared exactly as in Example 2 but with the addition of 0.02% w/v bendiocarb compound as a additional adjuvant to give the resultant aqueous suspension concentrate, Example 3.

### EXAMPLE 4

An aqueous suspension concentrate is prepared exactly as in Example 1 but with the addition of the urea compound, 0.4% w/v diuron, instead of the carbamate (carbaryl or bendiocarb) compounds, to give the resultant aqueous suspension concentrate, Example 4.

### EXAMPLE 5

An aqueous suspension concentrate is prepared exactly as in Example 1 but with the addition of an amide compound, 0.4% w/v monalide, instead of the carbamate (carbaryl or bendiocarb) compounds, to give the resultant aqueous suspension concentrate, Example 5.

### EXAMPLE 6

An aqueous suspension concentrate is prepared exactly as in Example 1 but with the substitution of propanil as the active ingredient with 30% w/v anilide herbicide Pentanochlor, to give the resultant aqueous suspension concentrate, Example 6.

### EXAMPLE 7

An aqueous suspension concentrate is prepared exactly as in Example 2 but with the substitution of propanil as the active ingredient with 30% w/v anilide herbicide Pentanochlor and 0.08% w/v carbaryl, to give the resultant aqueous suspension concentrate, Example 7.

### EXAMPLE 8

An aqueous suspension concentrate is prepared exactly as in Example 1 but with the substitution of propanil as the active ingredient with 50% w/v anilide herbicide Chloranoacryl to give the resultant aqueous suspension concentrate, Example 8.

### EXAMPLE 9

An aqueous suspension concentrate is prepared exactly as in Example 2 but with the substitution of propanil as the active ingredient with 50% w/v anilide herbicide Chloranoacryl and 0.02% w/v carbaryl to give the resultant aqueous suspension concentrate, Example 9.

### EXAMPLE 10

An aqueous suspension concentrate is prepared exactly as in Example 1 but with the substitution of propanil as the active ingredient with the 40% w/v non-anilide herbicide, entobenzanid, to give the resultant aqueous suspension concentrate, Example 10.

### EXAMPLE 11

An aqueous suspension concentrate is prepared exactly as in Example 2 but with the substitution of propanil as the active ingredient with 40% w/v non-an aide herbicide, entobenzanid, to give the resultant aqueous suspension concentrate, Example 11.

### EXAMPLE 12

An aqueous suspension concentrate is prepared exactly as in Example 1 but with the substitution of propanil as the active ingredient with 40% w/v non-an aide herbicide, dichlormate, to give the resultant aqueous suspension concentrate, Example 12.

### EXAMPLE 13

An aqueous suspension concentrate is prepared exactly as in Example 2 but with the substitution of propanil as the active ingredient with40% v/v non-anilide herbicide, dichlormate, to give the resultant aqueous suspension concentrate, Example 13.

### EXAMPLE 14

An aqueous suspension concentrate is prepared exactly as in Example 1 but with the substitution of propanil as the active ingredient with 40% w/v non-an aide herbicide, SWEP, to give the resultant aqueous suspension concentrate, Example 14.

### EXAMPLE 15

An aqueous suspension concentrate is prepared exactly as in Example 2 but with the substitution of propanil as the active ingredient with 40% w/v non-anilide herbicide, SWEP, to give the resultant aqueous suspension concentrate, Example 15.

### EXAMPLE 16

Results of the stability performance of Examples 1-12 suspension concentrates after 3 days at 54° C. accelerated storage test.

| Suspension | Stability as measured by % |
|---|---|
| Concentrate Tested | caking @ 54 C. for 2 days |
| 1 | 37% |
| 2 | 16% |
| 3 | 22% |
| 4 | 39% |
| 5 | 33% |
| 6 | 38% |
| 7 | 21% |
| 8 | 29% |
| 9 | 20% |
| 10 | 13% |
| 11 | 17% |
| 12 | 14% |
| 13 | 13% |
| 14 | 9% |
| 15 | 13% |

As can be seen from the results in the table above, the anilide herbicides, Propanil (Example 2 versus 1), Pentanochlor Examples 7 versus 6) and Chloranoacryl (Examples 9 versus 8) showed an improvement in stability of the suspension concentrate formulation when a carbamate compound, namely carbaryl was included in the formulation.

The anilide herbicide Propanil, also showed an improvement in the stability of the suspension concentrate formulation when the carbamate compound was changed to the structurally related carbamate, bendiocarb in the suspension concentrate formulation. (Example 3 versus 1)

The non-carbamate compounds, Diuron, a structurally related urea-based herbicide (Example 4 versus 1) and Monalide, a structurally related amide-based herbicide (Example 5 versus 1) showed no improvement in stability of the suspension concentrate formulation when these structurally related non-carbamate compounds were used instead of the carbamate compounds, carbaryl and bendiocarb.

When a series of non-anilide herbicides were compared for stability of the suspension concentrates with and without carbaryl, the results showed that carbaryl addition played no role in improving the stability of non-anilide herbicide suspension concentrates—Etobenzanid (Example 10 versus 11), Dichlormate (Example 12 versus 13) and SWEP (Example 14 versus 15).

Thus it can be clearly shown from the examples above the unexpected and surprising stabilizing effect of carbamate compounds, preferably carbaryl and bendiocarb, on improving the gelling, caking and settling properties of the suspension concentration formulations of only anilide herbicides. Further this effect could not be predicted from the prior art and is absent for compounds, which are structurally similar to the carbamates, such as amide and urea pesticides.

What is claimed is:

1. A stable aqueous suspension concentrate composition of anilide herbicides, comprising coformulants such as surfactants, wetting agents and dispersing agents and a carbamate crystallization suppressant.

2. The formulation according to claim 1, wherein the anilide herbicide is preferably propanil, comprising, on a weight-to-volume basis, from 30.0% to 50% of the total formulation.

3. The formulation according to claim 1, wherein the carbamate crystallization suppressant is preferably carbaryl, comprising, on a weight-to-volume basis, from 0.02% to 0.08% of the total formulation.

4. The formulation according to claim 1, wherein the anilide herbicide—surfactant—wetting agent—dispersing agent mixture has a droplet size of less than 10 microns and preferably less than 5 microns, after wet milling.

5. The formulation according to claim 4 further comprising an anti-freezing agent, an anti-foam agent and a preservative after the milling of the emulsion is complete.

6. The formulation according to claim 1, wherein the surfactant, dispersing agent is an ethylene oxide/propylene oxide condensate; an alkyl,aryl-ethoxylate an aryl,aryl-ethoxylate or a derivative thereof; a lignosulfonate; a cresol-formaldehyde condensate; a sulfonated cresol-formaldehyde condensate; a naphthalene-formaldehyde condensate; a sulfonated naphthalene-formaldehyde condensate; a polycarboxylate or a derivative thereof; alkyl, arylethoxylate, a triethanolamine or potassium salt of polyarylarylethoxylate phosphate, a polyarylarylpolyoxyethylene phosphoric acid, sodium cresol-formaldehyde condensate, sodium salt of sulfonated cresol-formaldehyde condensate or a mixture thereof.

7. The formulation according to claim 5, wherein the antifreezing agent is ethylene glycol, propylene glycol, glycerine, urea or a mixture thereof.

8. The formulation according to claim 5, wherein said preservative is a 38% formaldehyde solution, methyl or propyl parahydroxybenzoate, 2-bromo-2-nitro-propane-1,3-diol, sodium benzoate, glutaraldehyde, o-phenylphenol, benzisothiazolinone, 5-chloro-2-methyl-4-isothiazolin-3-one, pentachlorophenol, 2,4-dichlorobenzylalcohol or a mixture thereof.

9. A method of production of aqueous suspension concentrate according to claim 1, wherein said method prepares a stable aqueous suspension concentrate composition comprising, on a weight to volume basis, about 37% -43% propanil, up to about 6% -8% dispersing and wetting agents, 4% -7% antifreezing agent, 0.05% -0.4% antimicrobial. agent, 0.5% -3% thickening agent and anti-foam agent and sufficient water to total 100%.
